(19) United States
(12) Patent Application Publication
(10) Pub. No.: US 2025/0189076 A1
(43) Pub. Date: Jun. 12, 2025

(54) POWERED SAW HAND DETECTION AND CONTROL

(71) Applicant: Milwaukee Electric Tool Corporation, Brookfield, WI (US)

(72) Inventors: Jackson Thomas Hellmers, Brookfield, WI (US); Dapeng Zhao, Franksville, WI (US); Alexander Yu, Alpharetta, GA (US)

(21) Appl. No.: 18/973,388

(22) Filed: Dec. 9, 2024

Related U.S. Application Data
(60) Provisional application No. 63/608,034, filed on Dec. 8, 2023.
(60) Provisional application No. 63/616,115, filed on Dec. 29, 2023.

(51) Int. Cl. F16P 3/14; B23D 45/04; B26D 7/24

(52) U.S. Cl. CPC F16P 3/142; B23D 45/042; B26D 7/24

(57) ABSTRACT

A powered saw includes at least one camera, a sensor, a saw blade, a motor configured to drive the saw blade, and an electronic controller including an electronic processor and a memory. The electronic controller receives an indication of an orientation of the saw blade from the sensor and determines a keep-out area based on the orientation of the saw blade, where the keep-out area corresponds to, or is defined relative to, the saw blade. Images captured from the at least one camera are received by the electronic controller, where the captured images include at least a portion of the keep-out area. The electronic controller analyzes, using a machine learning (ML) model, the captured images to determine whether a portion of a hand is present in the keep-out area and, in response to detecting the portion of the hand in the keep-out area, executes a safety action.

### CROSS-REFERENCE TO RELATED APPLICATIONS

This application claims the benefit of U.S. Provisional Patent Application Ser. No. 63/608,034, filed on Dec. 8, 2023, and entitled “POWERED SAW HAND DETECTION AND CONTROL,” and U.S. Provisional Patent Application Ser. No. 63/616,115, filed on Dec. 29, 2023, and entitled “POWERED SAW HAND DETECTION AND CONTROL,” each of which are herein incorporated by reference in their entirety.

### BACKGROUND

Powered saw tools include a motor driving (e.g., rotating) a saw blade at a high speed to cut through a work material (e.g., wood, plastic, metal). These tools can include miter saws, table saws, circular saws, panel saws, and the like, and are widely utilized in construction, woodworking, and various other industries to allow users to make controlled cuts in a range of materials. For various reasons, an injury may result through use of a powered saw tool when a saw blade being driven comes into contact with a user's hand.

### SUMMARY OF THE DISCLOSURE

The present disclosure provides a powered saw that includes a camera; an inertial measurement unit (IMU) sensor; a saw blade; a motor configured to drive the saw blade; and an electronic controller including an electronic processor and a memory. The electronic controller is configured to: receive an indication of an orientation of the saw blade from the IMU sensor; determine a keep-out area based on the orientation of the saw blade, the keep-out area corresponding to the saw blade; receive captured images from the camera, the captured images including at least a portion of the keep-out area; analyze, using a machine learning (ML) model, the camera images to determine whether a portion of a hand is present in the keep-out area; and in response to detecting the portion of the hand in the keep-out area, execute a safety action.

It is another aspect of the present disclosure to provide a method of operating a powered saw. The method includes receiving an indication of an orientation of a saw blade from a sensor of the powered saw; determining a keep-out area based on the orientation of the saw blade, the keep-out area defining a volume relative to the saw blade; receiving image data from a camera of the powered saw, the image data depicting at least a portion of the keep-out area; analyzing, using an ML model, the camera images to determine whether a portion of a hand is present in the keep-out area; and executing a safety action in response to detecting the portion of the hand in the keep-out area. Other embodiments of this aspect include corresponding systems (e.g., computer systems), programs, algorithms, and/or modules, each configured to perform the steps of the methods.

### BRIEF DESCRIPTION OF THE DRAWINGS

FIG. 1A illustrates an example miter saw according to some embodiments.

FIG. 1B illustrates an example camera assembly coupled to a miter saw according to some embodiments.

FIG. 1C illustrates an example miter saw having two cameras coupled thereto, according to some embodiments.

FIG. 1D illustrates an example of a three-dimensional keep-out area being projected onto a two-dimensional camera plane.

FIG. 1E illustrates an example of a warning keep-out area according to some embodiments.

FIG. 1F illustrates an example of a danger keep-out area according to some embodiments.

FIGS. 2A and 2B illustrate an example table saw according to some embodiments.

FIG. 3 is a block diagram of a powered saw tool according to some embodiments.

FIG. 4 is a flowchart illustrating an example method for controlling the operation of a powered saw according to some embodiments.

FIG. 5 is a flowchart illustrating an example method for detecting an unsafe operating condition of a powered saw according to some embodiments.

FIG. 6 illustrates example images captured using cameras coupled to a miter saw.

FIG. 7 is a flowchart illustrating an example method for identifying whether a detected hand is present in a keep-out area of a powered saw according to some embodiments.

FIG. 8 illustrates an example for estimating a pose of a miter saw according to some embodiments.

FIG. 9A illustrates an example of a detected hand object identified as intersecting with a warning keep-out area.

FIG. 9B illustrates an example of a detected hand object identified as intersecting with a danger keep-out area.

FIG. 10 is a flowchart illustrating an example method for training a machine learning model for hand detection according to some embodiments.

FIG. 11 is a flowchart illustrating an example method for detecting an unsafe operating condition of a power saw based on processing image data with an optical flow detection model.

### DETAILED DESCRIPTION

Provided herein are systems and methods for detecting a user's hand in one or more keep-out areas (e.g., near the saw blade or a path of the saw blade) during operation of a powered saw and, in response, controlling the powered saw to execute a safety action (e.g., generating a warning, stopping the saw blade, or both generating the warning and stopping the saw blade).

In some embodiments described herein, a powered saw determines a keep-out area based on output of sensors (e.g., inertial sensors such as an inertial measurement unit (IMU)), executes a machine learning (ML) model to analyze camera images that include the keep-out area, and, in response to detecting a user's hand in the keep-out area, executes a safety action (e.g., generating a warning and/or stop the motor).

The disclosed hand detection techniques have robust detection capabilities. For example, rather than being limited to detecting flesh (e.g., through a capacitive sensor), certain optical characteristics (e.g., particular skin tones, work glove colors (e.g., green or blue work gloves), etc.), or certain lighting conditions, the hand detection techniques can detect a hand in various scenarios (e.g., in a glove, partially obstructed views of hands covered by clothing, various lighting conditions, having different skin tones, with the powered saw operating at different miter and bevel angles, etc.). This robustness results from, for example, training of the ML model that detects hands using images capturing these various scenarios. Additionally, the hand detection techniques can be adaptable based on the pose or orientation of the powered saw. For example, the hand detection techniques may define a keep-out area based on an output from an IMU or other sensor attached to the saw (e.g., an arm of the saw), which enables the hand detection techniques to account for different miter and bevel angles. That is, the keep-out area may be defined based on an output of the IMU or other sensors, such that the keep-out area may be dynamically changed or updated as the miter and/or bevel angle of the saw blade is changed by the user.

In addition to detecting the presence of hands in a keep-out area of a powered saw, the systems and methods described in the present disclosure can also be used to other tools where a workpiece is movable, or where the user's hands may come into close contact with a moving component of the tool. In these instances, the location of the workpiece can be detected and tracked relative to a keep-out area and/or the user's hands can be detected and tracked relative to a keep-out area. For example, the techniques described herein could be applied to other power tools and industrial machines, including planers, joiners, routers, drill presses, hydraulic presses, and so on.

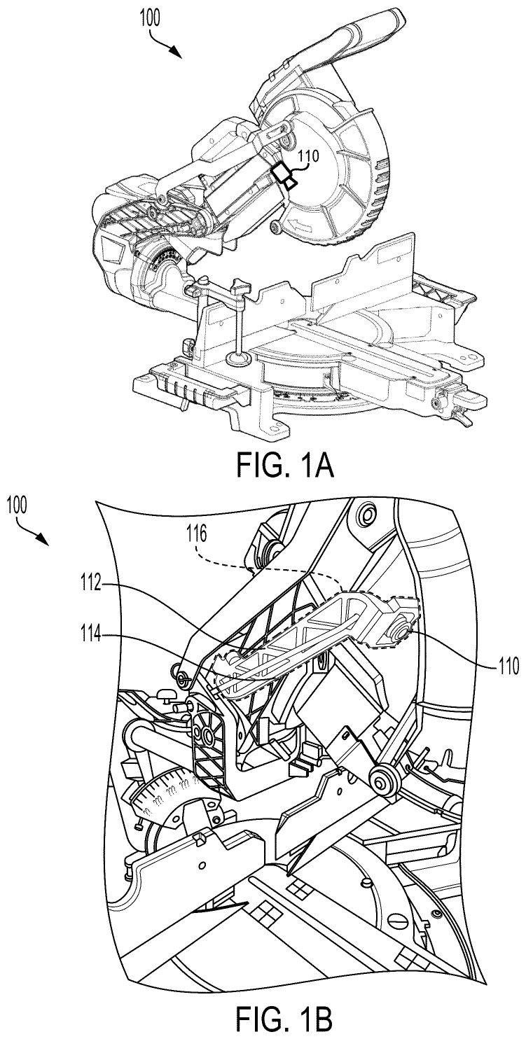

FIGS. 1A-1C illustrate a miter saw 100 according to some embodiments. The miter saw 100 is an example of a powered saw that may implement the hand detection and control techniques described herein. As illustrated, the miter saw 100 includes one or more cameras 110 coupled to the miter saw 100. The camera(s) 110 may be coupled to the housing of the miter saw 100, an arm of the miter saw 100, or the like. In the illustrated example shown in FIG. 1B, a camera 110 may be mounted on, or otherwise coupled to, a boom 112 that is coupled to the housing of the miter saw 100.

An indicator light 114 (e.g., a feedback light) may be coupled to or otherwise integrated with the boom 112. As will be described below in more detail, the indicator light 114 may be operable to execute a safety action in response to a hand being detected in a keep-out area of the miter saw 100. For instance, the indicator light 114 may be operable to generate different colored light based on the executed safety action. As a non-limiting example, when a warning safety action is executed (e.g., when a hand is detected in a warning keep-out area), the indicator light 114 may be operated to generate a yellow-colored light. When a danger safety action is executed (e.g., when a hand is detected in a danger keep-out area), the indicator light 114 may be operated to generate a red-colored light. When the miter saw 100 is operating under safe conditions (e.g., when no hand is detected in a keep-out area), the indicator light 114 may be operated to generate a green-colored light. The indicator light 114 may be a light-emitting diode (LED), an LED strip, an LED array, or other suitable light. Collectively, the camera 110, boom 112, and indicator light 114 may form a camera assembly 116. One or more such camera assemblies 116 may be coupled to the miter saw 100, such as one camera assembly 116 on each side of the blade of the miter saw 100.

As illustrated in FIG. 1C, in some examples, two cameras 110a, 110b are coupled to the miter saw 100. In the illustrated example, a first camera 110a is coupled to, or mounted on, one side of the blade of the miter saw 100, and a second camera 110b is coupled to, or mounted on, the other side of the blade of the miter saw 100. In some examples, the cameras 110a, 110b can be arranged close to the blade of the miter saw 100, such that the field-of-view of the cameras 110a, 110b can aligned along the length of the blade. Having the cameras 110a, 110b arranged in close proximity to the blade can help reduce ambiguity along the depth direction of the cameras 110a, 110b.

An example of a keep-out area 150 for a miter saw 100 is illustrated in FIG. 1D. In this illustrated example, the keep-out area 150 is generally defined by a volume extending about the saw blade of the miter saw 100. The keep-out area 150 may constitute a single zone, area, or volume, or may be composed of multiple keep-out areas. For instance, a warning zone of the keep-out area 150 (e.g., a warning keep-out area 152) may be defined as a zone where a user is at increased risk of injury, but not at immediate risk of injury. Similarly, a danger zone of the keep-out area (e.g., a danger keep-out area 154) may be defined as a smaller zone where a user is at an immediate risk of injury. The danger zone may be at least partially contained within the warning zone, such that the danger keep-out area 154 may be smaller than, and at least partially contained within, the warning keep-out-area. As will be described in more detail below, the volume of the keep-out area 150 (or warning keep-out area 152 and danger keep-out area 154) are projected onto a plane, such as the two-dimensional (2D) camera plane 156 associated with one or more of the cameras 110, thereby forming a projected keep-out area 158. A detected hand object 160 is tracked and when the detected hand object 160 intersects with the projected keep-out area 158 one or more safety actions may be executed.

As a non-limiting example, when the hand object 160 intersects with a projected warning keep-out area, one or more executed safety actions may include outputting an auditory (or audible) warning to the user, outputting a visual warning to the user, or both outputting an auditory warning and outputting a visual warning to the user. The auditory warning may include an intermittent auditory warning (e.g., a series of tones, beeps, etc.) played by a speaker on the miter saw 100. The visual warning may include generating a yellow-colored light via the indicator light 114. When the hand object 160 intersects with a projected danger keep-out area, one or more executed safety actions may include stopping operation of the saw blade (e.g., by mechanically braking the blade, electronically braking the saw blade, etc.), outputting an auditory warning to the user, outputting a visual warning to the user, or combinations thereof. The auditory warning may include a constant tone played by a speaker on the miter saw 100. The visual warning may include generating a red-colored light via the indicator light 114.

As illustrated in FIG. 1E, in a non-limiting example, a warning keep-out area 152 may correspond to a volume extending through the kerf plate of the miter saw 100. As illustrated in FIG. 1F, in a non-limiting example, a danger keep-out area 154 may correspond to a volume extending through the slot in the kerf plate, through which the saw blade is allowed to pass when completing a cut through a work piece, or may otherwise be defined by a cut plane of the saw blade. The size and shape of each keep-out area 150 (e.g., warning keep-out area 152, danger keep-out area 154) can be predetermined, adjusted by the user, and/or dynamically adjusted during operation of the miter saw 100. For example, the width of each keep-out area 150 can be adjusted by the user and/or dynamically adjusted during operation of the miter saw 100 (e.g., by changing the miter angle and/or bevel angle of the saw blade).

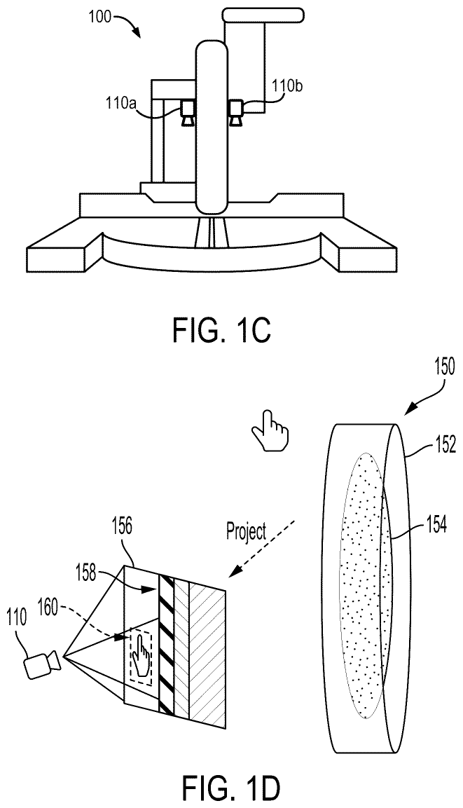

FIGS. 2A and 2B illustrate a table saw 200 according to some embodiments. Like the miter saw 100, the table saw 200 is an example of a powered saw that may implement the hand detection and control techniques described herein. The table saw 200 includes one or more cameras 210 coupled to the table saw 200. In the illustrated example, two cameras 210a, 210b are coupled to the table saw 200 via a boom 212. The cameras 210a, 210b are coupled to, or otherwise mounted on, the boom 212, which is coupled to the frame or housing of the table saw 200. The boom 212 can be a relatively thin support for the cameras 210a, 210b. For example, the boom 212 can have a similar or thinner width than the riving knife 232 of the table saw 200, such that material may be allowed to pass by the boom 212 as a work piece is being cut by the blade 230 of the table saw 200. The cameras 210a, 210b may be coupled to, or otherwise mounted on, the boom 212 such that they are angled and to the side of the blade 230 to avoid the blade guard. Although not illustrated in FIG. 2A or 2B, an indicator light may also be coupled to the boom 212, similar to the indicator light 114 illustrated in FIG. 1B.

Similar to the miter saw 100, the table saw 200 can have one or more keep-out areas defined relative to the blade 230. For example, a warning keep-out area may be defined by a volume extending through the kerf plate of the table saw 200, and a danger keep-out area may be defined by a volume extending through the slot in the kerf plate, or otherwise extending through the cut plane of the table saw 200.

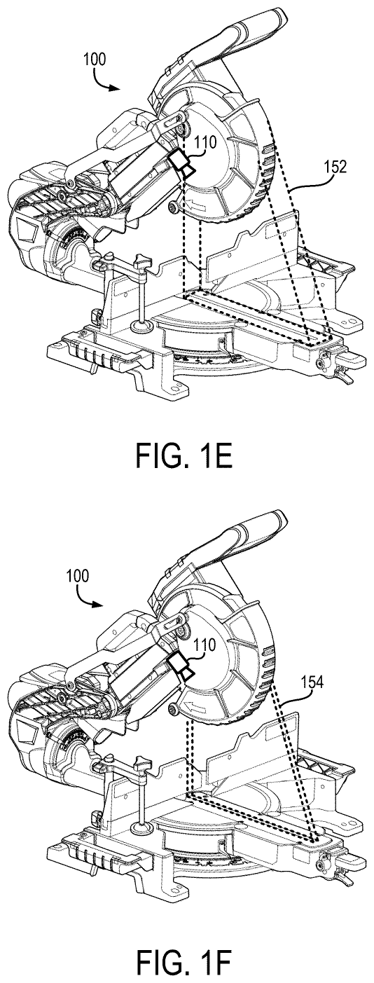

FIG. 3 illustrates a block diagram of an example powered saw 300. The powered saw 300 may be a miter saw (e.g., miter saw 100 illustrated in FIG. 1A), a table saw (e.g., table saw 200 illustrated in FIG. 2A), or another suitable type of powered saw. Thus, the block diagram of FIG. 3 applies to examples of the miter saw 100 and the table saw 200, amongst other types of powered saws. In other examples, the powered saw 300 is implemented as a different type of powered saw than the illustrated examples of the miter saw 100 and the table saw 200.

The powered saw 300 includes an electronic controller 320, a power source 352 (e.g., a battery pack, a portable power supply, and/or a wall outlet), etc. In the illustrated embodiment, the powered saw 300 also includes a wireless communication device 360. In other embodiments, the powered saw 300 may not include a wireless communication device 360.

The electronic controller 320 can include an electronic processor 330 and memory 340. The electronic processor 330 and the memory 340 can communicate over one or more control buses, data buses, etc., which can include a device communication bus 354. The control and/or data buses are shown generally in FIG. 3 for illustrative purposes. The use of one or more control and/or data buses for the interconnection between and communication among the various modules, circuits, and components would be known to a person skilled in the art.

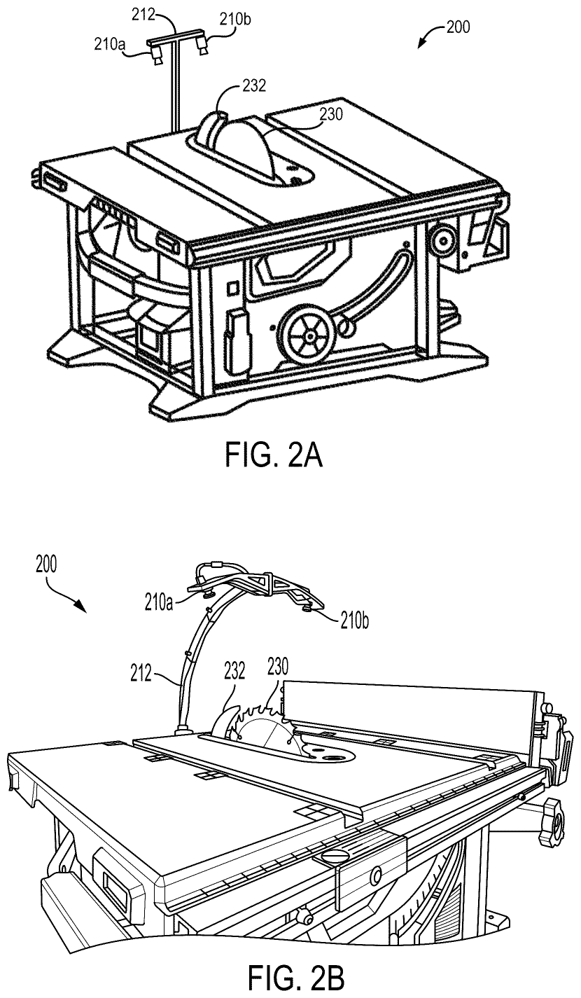

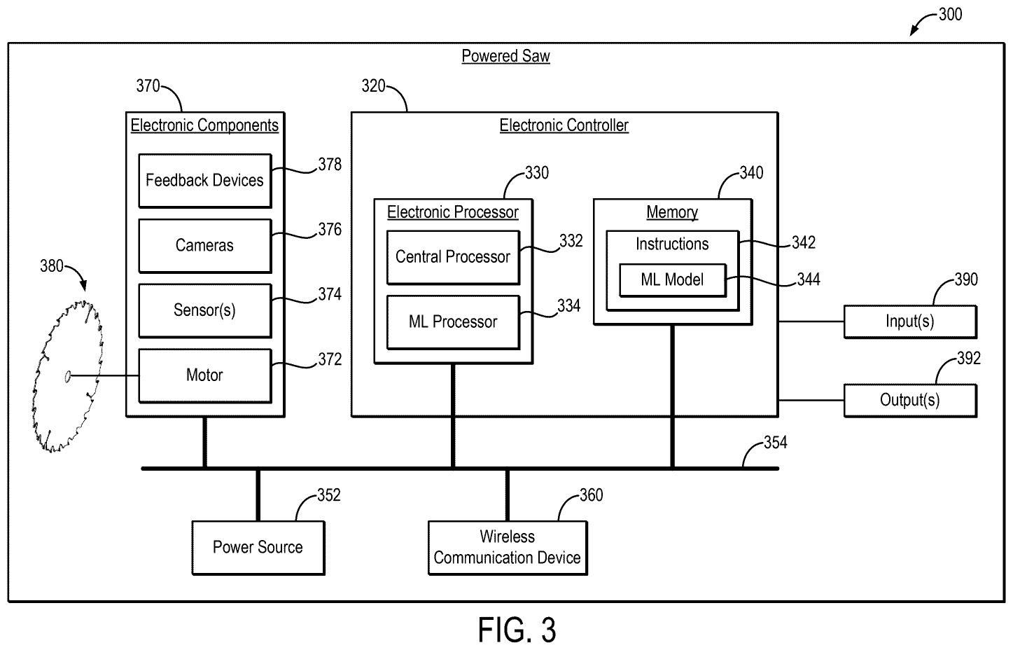

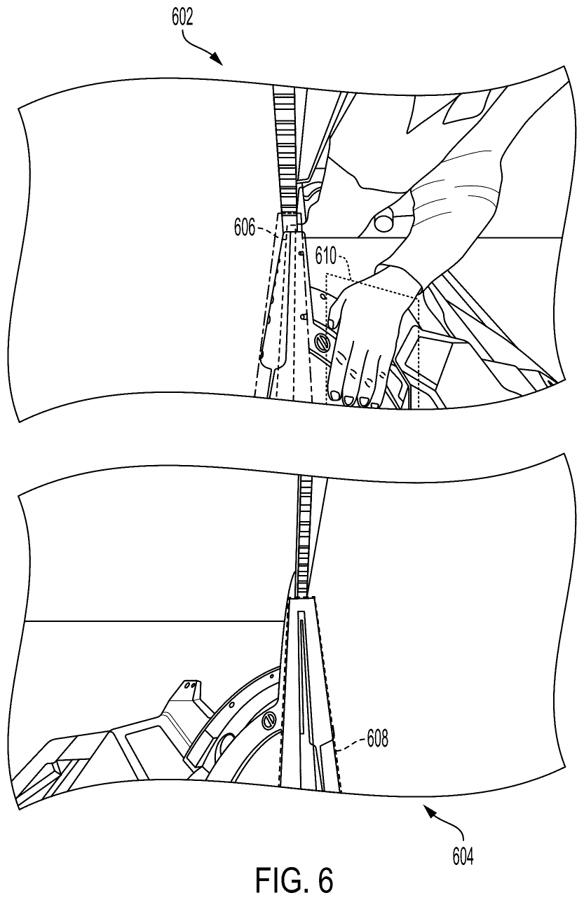

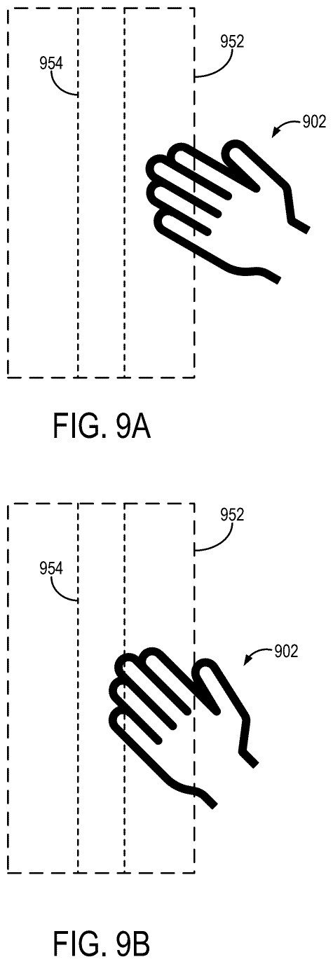

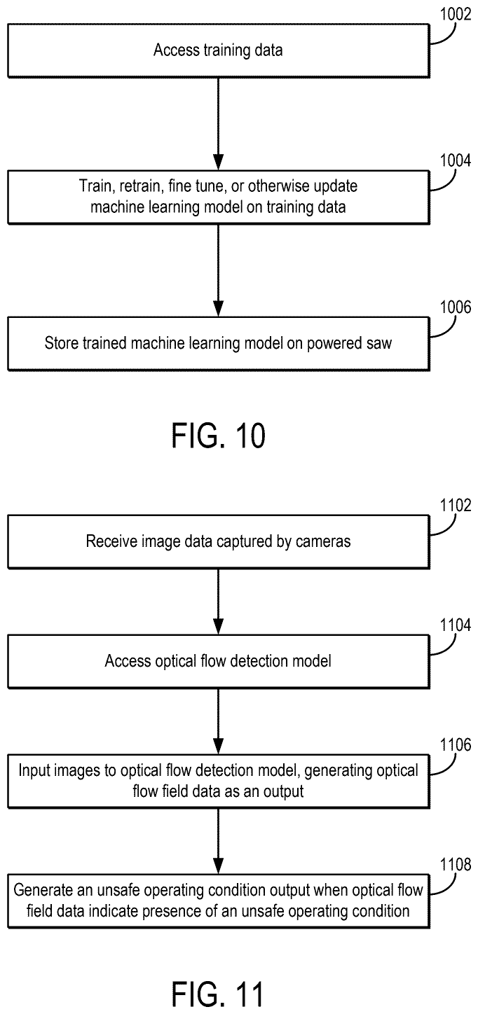

The electronic processor 330 can be configured to communicate with the memory 340 to store data and retrieve stored data. The electronic processor 330 can be configured to receive instructions 342 and data from the memory 340 and execute, among other things, the instructions 342. In particular, the electronic processor 330 executes instructions 342 stored in the memory 340. Thus, the electronic controller 320 coupled with the electronic processor 330 and the memory 340 can be configured to perform the methods described herein (e.g., one or more aspects of the process 400 of FIG. 4; one or more aspects of the process 500 of FIG. 5; one or more aspects of the process 700 of FIG. 7; one or more aspects of the process 1000 of FIG. 10; and/or one or more aspects of the process 1100 of FIG. 11).

In some examples, the electronic processor 330 includes one or more electronic processors. For example, as illustrated, the electronic processor 330 includes a central processor 332 and a machine learning (ML) processor 334. In other examples, the functions of the central processor 332 and/or the ML processor 334 are combined into a single processor or further distributed among additional processors.

Additionally or alternatively, the electronic processor 330 (or the central processor 332 or ML processor 334) may include one or more artificial intelligence (AI) accelerator cores. The AI accelerator core may include specialized processing units (e.g., arithmetic logic units (ALUs), floating-point units (FPUs), etc.), that are configured to execute the specific operations involved in neural network training and/or inference. As a non-limiting example, the processing units of the AI accelerator core may be organized to facilitate parallel processing, allowing for the simultaneous execution of multiple computations.

The memory 340 can include read-only memory (“ROM”), random access memory (“RAM”), other non-transitory computer-readable media, or a combination thereof. As described above. the memory 340 can include instructions 342 for the electronic processor 330 to execute. The instructions 342 can include software executable by the electronic processor 330 to enable the electronic controller 320 to, among other things, receive data and/or commands, transmit data, control operation of the powered saw 300, and the like. For example, the instructions 342 may include software executable by the electronic processor 330 to enable the electronic controller 320 to, among other things, implement the various functions of the electronic controller 320 described herein, including performing hand detection and controlling operation of the powered saw 300. The software can include, for example, firmware, one or more applications, program data, filters, rules, one or more program modules, and other executable instructions.

As illustrated, the memory 340 can also store a machine learning (ML) model 344. The ML model 344 may be a pretrained machine learning model (e.g., a neural network, another machine learning model trained for object detection) that is executed by the electronic processor 330. In some examples, the ML processor 334 may execute the ML model 344 to perform the hand detection for the powered saw 300, as described herein. In other words, the ML processor 334 may serve as a dedicated processor to execute the ML model 344 to detect hands, as described herein. In such examples, the central processor 332 may perform other control for the powered saw 300, such as, for example, enabling and disabling a motor (e.g., motor 372).

The electronic processor 330 is configured to retrieve from memory 340 and execute, among other things, instructions 342 related to the control processes and methods described herein. The electronic processor 330 is also configured to store data on the memory 340 including usage data (e.g., usage data of the powered saw 300), maintenance data (e.g., maintenance data of the powered saw 300), feedback data, power source data, sensor data (e.g., sensor data of the powered saw 300), environmental data, operator data, location data, and the like.

In some examples, the electronic processor 330 can receive instructions 342 from the memory 340 that include settings or configurations for the size and shape of one or more keep-out areas; the type, duration, and/or volume of auditory warnings; the type of visual warnings; and so on. These powered saw settings can be received and/or updated wirelessly through an application (e.g., an app), customized in firmware (e.g., programmed for particular users at manufacture or with firmware updates), customized via inputs directly on the power tool device (e.g., via a button, switch, set of user interface actions, controls on a screen, etc.).

The power source 352 can be an AC power source or a DC power source, which can be in electrical communication with one or more power outlets (e.g., AC or DC outlets). For instance, the power source 352 can be an AC power source, for example, a conventional wall outlet, or the power source 352 can be a DC power source, for example, a battery pack.

In some examples, the power source 352 may include a battery pack interface and selectively attachable and removable power tool battery pack. The pack interface may include one or more power terminals and, in some cases, one or more communication terminals that interface with respective power and/or communication terminals of the power tool battery pack. The power tool battery pack may include one or more battery cells of various chemistries, such as lithium-ion (Li-Ion), nickel cadmium (Ni-Cad), and the like. The power tool battery pack may further selectively latch and unlatch (e.g., with a spring-biased latching mechanism) to the powered saw 300 to prevent unintentional detachment. The power tool battery pack may further include a pack electronic controller (e.g., pack controller) including a processor and a memory. The pack controller may be configured similarly to the electronic controller 320. The pack controller may be configured to regulate charging and discharging of the battery cells, and/or to communicate with the electronic controller 320.

In other examples, the powered saw 300 may be corded and the power source 352 may include a corded power interface, e.g., to receive external power from a wall outlet or the like (e.g., AC power).

In some embodiments, the powered saw 300 may also include a wireless communication device 360. In these embodiments, the wireless communication device 360 is coupled to the electronic controller 320 (e.g., via the device communication bus 354). The wireless communication device 360 may include, for example, a radio transceiver and antenna, a memory, and an electronic processor. In some examples, the wireless communication device 360 can further include a GNSS receiver configured to receive signals from GNSS satellites, land-based transmitters, etc. The radio transceiver and antenna operate together to send and receive wireless messages to and from an external device (e.g., a smartphone, a tablet computer, a cellular phone, a laptop computer, a smart watch, a headset, a heads-up display, virtual reality (“VR”) goggles, augmented reality (“AR”) goggles, a security camera, a web camera, and the like), one or more additional power tool devices (e.g., a power tool battery charger, a power tool battery pack, a power tool, a work light, a power tool pack adapter, as well as other devices used in conjunction with power tool battery chargers, power tool battery packs, and/or power tools), a server, and/or the electronic processor of the wireless communication device 360. The memory of the wireless communication device 360 stores instructions to be implemented by the electronic processor of the wireless communication device 360 and/or may store data related to communications between the powered saw 300 and the external device, one or more additional power tool devices, and/or the server.

The electronic processor of the wireless communication device 360 controls wireless communications between the powered saw 300 and the external device, one or more additional power tool devices, and/or the server. For example, the electronic processor of the wireless communication device 360 buffers incoming and/or outgoing data, communicates with the electronic processor 330 of the powered saw 300 and determines the communication protocol and/or settings to use in wireless communications.

In some embodiments, the wireless communication device 360 is a Bluetooth® controller. The Bluetooth® controller communicates with the external device, one or more additional power tool devices, and/or the server employing the Bluetooth® protocol. In such embodiments, therefore, the external device, one or more additional power tool devices, and/or the server and the powered saw 300 are within a communication range (i.e., in proximity) of each other while they exchange data. In other embodiments, the wireless communication device 360 communicates using other protocols (e.g., Wi-Fi®, cellular protocols, a proprietary protocol, etc.) over a different type of wireless network. For example, the wireless communication device 360 may be configured to communicate via Wi-Fi® through a wide area network such as the Internet or a local area network, or to communicate through a piconet (e.g., using infrared or NFC communications). The communication via the wireless communication device 360 may be encrypted to protect the data exchanged between the powered saw 300 and the external device, one or more additional power tool devices, and/or the server from third parties.

The wireless communication device 360, in some embodiments, exports usage data, other power tool device data, and/or other data as described above from the power tool device 102 (e.g., from the electronic processor 330).

In some embodiments, the wireless communication device 360 can be within a separate housing along with the electronic controller 320 or another electronic controller, and that separate housing selectively attaches to the power tool device 102. For example, the separate housing may attach to an outside surface of the power tool device 102 or may be inserted into a receptacle of the power tool device 102. Accordingly, the wireless communication capabilities of the power tool device 102 can reside in part on a selectively attachable communication device, rather than integrated into the power tool device 102. Such selectively attachable communication devices can include electrical terminals that engage with reciprocal electrical terminals of the power tool device 102 to enable communication between the respective devices and enable the power tool device 102 to provide power to the selectively attachable communication device. In other embodiments, the wireless communication device 360 can be integrated into the power tool device 102. In some embodiments, the wireless communication device 360 is not included in the power tool device 102.

The electronic components 370 include a motor 372, one or more sensors 374, one or more cameras 376, and one or more feedback devices 378.

In some examples, the motor 372 is configured to rotate the saw blade 380. The electronic components 370 may also include additional sensors and circuitry to control the motor 372. For example, the electronic components 370 may include an inverter bridge controlled with pulse width modulated signals (generated by the electronic controller 320) to drive the motor 372. The motor 372 may be, for example, a brushed or brushless motor.

The one or more sensors 374 may include an accelerometer, gyroscope, magnetometer, angle encoders, or other sensing device configured to output an indication of an orientation thereof. The sensor(s) 374 may be mounted on an arm of the powered saw 300 or otherwise connected to a moveable component of the powered saw 300 that tracks movement of the saw blade 380 (e.g., translation of the saw blade 380, change in orientation of the saw blade 380, rotation of the saw blade 380 during operation, etc.). Accordingly, the output of the sensor(s) 374 may indicate a position and/or orientation of the saw blade 380 including a miter angle, a bevel angle, or both. Collectively, the position and/or orientation of the saw blade 380 may be referred to as the pose of the saw blade 380. The output of the sensor(s) 374 may be provided to the electronic controller 320 (e.g., the electronic processor 330 and/or ML processor 334) to determine a position, orientation, and/or pose of the saw blade 380 and/or the powered saw 300.

In some examples, the sensor(s) 374 may additionally include one or more of voltage sensors or voltage sensing circuits, current sensors or current sensing circuits, temperature sensors or temperature sensing circuits, pressure sensors or pressure sensing circuits (e.g., a barometer), or the like. The powered saw 300 may also include connections (e.g., wired or wireless connections) for external sensors.

The cameras 376 may capture and output image data to the electronic controller 320 (e.g., the electronic processor 330 and/or ML processor 334), which may serve as input to the ML model 344 executing on the electronic processor 330. The cameras 376 may include a left and right camera, each positioned on opposite (left and right) sides of the saw blade 380. For example, in the miter saw 100 illustrated in FIGS. 1A-1C, the cameras 376 may include cameras 110a, 110b, and in the table saw 200 illustrated in FIGS. 2A-2B, the cameras 376 may include cameras 210a, 210b.

The cameras 376 may be any suitable camera for recording or otherwise capturing images of a scene. The cameras 376 may thus capture single image frames or a series of images frames, or may record a video stream of the scene. To capture a wide field-of-view, the cameras 376 may include a wide-angle lens, a fish-eye lens, or the like.

The feedback devices 378 may be controlled by the electronic controller 320 (e.g., the electronic processor 330, central processor 332, and/or ML processor 334) to provide feedback to a user based on an output of the electronic controller 320 indicating whether an unsafe operating condition exists (e.g., when a hand is detected within one or more keep-out areas). The feedback devices 378 may include lights (e.g., LEDs), speakers, or both. As described above, the lights may include an indicator light that can provide a visual warning to a user when an unsafe operating condition is identified by the electronic controller 320. Similarly, the speaker may output an auditory warning when an unsafe operating condition is identified by the electronic controller 320.

The electronic components 370 may further include one or more switches (e.g., for initiating and ceasing operation of the powered saw 300), for waking the powered saw, or the like.

In some embodiments, the powered saw 300 can include one or more inputs 390 (e.g., one or more buttons, switches, and the like) that are coupled to the electronic controller 320 and allow a user to select a mode of the powered saw 300 (e.g., to place the powered saw 300 in a wake mode, or otherwise cause the electronic controller 320 to operate the cameras 376 to begin monitoring for hands in a keep-out area). In some embodiments, the input 390 includes a user interface (UI) element, such as an actuator, a button, a switch, a dial, a spinner wheel, a touch screen, or the like, that enable user interaction with the powered saw 300. As an example, the inputs 390 may include a UI element that allows for adjustment of a size and/or shape of one or more keep-out areas. For instance, a UI element may include a dial, spinner wheel, touch screen, or the like, that allows for a user to adjust a width of the projected area of a keep-out area. In some embodiments, the powered saw 300 may generate a visual indication of the size of the projected keep-out area, such as by projecting light onto the work surface of the powered saw indicating the size and shape of the projected keep-out area, or by generating such a visual indication on a display screen.

In some embodiments, the powered saw 300 may include one or more outputs 392 that are also coupled to the electronic controller 320. The output(s) 392 can receive control signals from the electronic controller 320 to present data or information to a user in response, or to generate other visual, audio, or other outputs. As one example, the output(s) 392 can generate a visual signal to convey information regarding the operation or state of the powered saw 300 to the user. The output(s) 392 may include, for example, LEDs or a display screen and may generate various signals indicative of, for example, an operational state or mode of the powered saw 300, an abnormal condition or event detected during the operation of the powered saw 300, and the like. For example, the output(s) 392 may indicate the state or status of the powered saw 300, an operating mode of the powered saw 300, and the like.

Referring now to FIG. 4, a flowchart is illustrated as setting forth the steps of an example method for controlling the operation of a powered saw.

The method includes waking up the powered saw, or otherwise initiating the detection of hands in one or more keep-out areas of the powered saw, as indicated at step 402. As described above, waking up the powered saw may include actuating a UI element (e.g., a button, switch, or the like) that wakes up the cameras of the powered saw to being capturing image data (e.g., images, video) of the keep-out areas and other work areas within the field-of-views of the cameras.

Based on the image data collected with the cameras, the powered saw monitors the work area to detect whether a hand enters into one or more keep-out areas, as indicated at step 404. As described below in more detail, the electronic controller of the powered saw can receive the image data from the cameras and process the image data to detect whether a hand is present in the scene.

When a hand is detected and identified as being present within a keep-out area, the powered saw will execute one or more safety actions in response to that unsafe operating condition, as indicated at step 406. As described above, the safety actions may include generating an auditory warning, generating a visual warning, stopping operation of the saw blade, or combinations thereof.

Referring now to FIG. 5, a flowchart is illustrated as setting forth the steps of an example method for detecting an unsafe operating condition of a powered saw.

The method includes receiving image data with the electronic controller 320 (e.g., the electronic processor 330), as indicated at step 502. In general, the image data include images or video captured by the cameras 376. The image data may be received by the electronic processor 330 from the cameras 376. Additionally or alternatively, the image data may be received from the memory 340 by the electronic processor 330. Additionally or alternatively, receiving the image data may include acquiring such data with the cameras 376 and transferring or otherwise communicating the image data to the electronic controller 320.

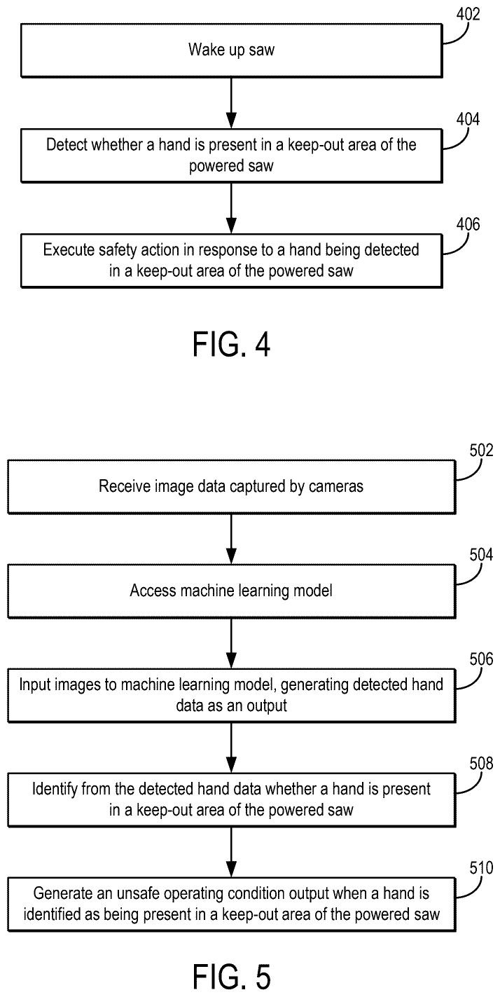

The images and/or video captured by the cameras 376 cover a field-of-view that includes at least a portion of one or more keep-out areas. In this way, the image data includes at least a portion of the keep-out area. An example of images captured with the cameras 376 is shown in FIG. 6. In the illustrated example, a first image 602 is captured with a first one of the cameras 376 (e.g., camera 110a) and a second image 604 is captured with a second one of the cameras 376 (e.g., camera 110b). For illustrative purposes, an example of a projected danger keep-out area 606 is highlighted in the first image 602 and an example of a projected warning keep-out area 608 is highlighted in the second image 604. A detected hand object 610 (e.g., a bounding box, in this example) is also shown in the first image 602.

In some examples, the image data may be stored for later use as training data for retraining, fine tuning, or otherwise updating a machine learning model. For example, the image data may be stored in the memory 340 of the electronic controller 320. The image data may then be read out from the memory 340 via a wired or wireless connection. For example, a user may connect an external device to the powered saw 300 via a wired connection (e.g., a USB cable) and read out the image data from the memory 340. Additionally or alternatively, the image data may be communicated via the wireless communication device 360 to an external device and/or server. In this way, image data collected during operation of the powered saw 300 may be used to create a training data set, or to supplement an existing training data set. As described below, the image data can be annotated to identify regions of the images containing a hand and these annotated image data can be stored as part of the training data set.

A trained machine learning model is then accessed with the electronic controller 320, as indicated at step 504. In general, the machine learning model is trained, or has been trained, on training data in order to detect hands in image data. The machine learning model may include one or more neural networks.

As a non-limiting example, the machine learning model may include a You Only Look Once (YOLO) object detection model. In general, a YOLO model is a one-stage object detection model that divides an input image into a grid and predicts bounding boxes and class probabilities directly. The YOLO model can process an entire image in a single forward pass. As another example, the machine learning model may include a single shot multibox detector model (SSD). In general, an SSD model is another one-stage object detection model that predicts bounding boxes and class scores at multiple scales. The SSD model can utilize feature maps from different layers to detect objects of varying sizes.

As another example, the machine learning model may include a faster region-based convolutional neural network (Faster R-CNN) model or a Mask R-CNN model. In general, a Faster R-CNN model is a two-stage object detection model that uses a region proposal network to generate region proposals, followed by a network for object detection. A Mask R-CNN model is an extension of Faster R-CNN, which adds an additional branch for pixel-level segmentation, thereby allowing the model to both detect objects and generate detailed masks for each object instance.

Other object detection models, including other one-stage object detection models and/or other two-stage object detection models, may also be used to detect hands.

Accessing the trained machine learning model may include accessing model parameters (e.g., weights, biases, or both) that have been optimized or otherwise estimated by training the machine learning model on training data. In some instances, retrieving the machine learning model can also include retrieving, constructing, or otherwise accessing the particular model architecture to be implemented. For instance, data pertaining to the layers in a neural network architecture (e.g., number of layers, type of layers, ordering of layers, connections between layers, hyperparameters for layers) may be retrieved, selected, constructed, or otherwise accessed.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs. As one example, the machine learning model may output detected hand data as a bounding box (e.g., a center coordinate of the bounding box, a height of the bounding box, a width of the bounding box). As another example, the machine learning model may output detected hand data as a cluster of pixels (e.g., a mask) categorized as corresponding to a hand.

The image data are then input to the machine learning model to perform hand detection, as indicated at step 506. For example, the electronic processor 330 may execute instructions for inputting the image data to the ML model 344. As described above, in some embodiments, the electronic processor 330 may include a separate ML processor 334 and/or one or more dedicated AI accelerator cores that can implement the ML model 344. In general, the machine learning model generates detected hand data as an output. As described above, the detected hand data may include a bounding box centered on each detected hand, a mask indicating a cluster of pixels corresponding to a detected hand, or the like. In this way, the electronic processor 330 (or ML processor 334) analyze the image data using the ML model 344 to determine whether a portion of a hand is present in the image data. The detected hand data may be stored in the memory 340, or in a memory cache of the electronic processor 330.

Based on the detected hand data, the electronic processor 330 identifies whether an unsafe operating condition exists by identifying when a hand is present in one or more keep-out areas of the powered saw, as indicated at step 508. As described above, and below in more detail, an unsafe operating condition can be identified when a hand (as represented by the detected hand data) intersects with a keep-out area (as represented by a projected keep-out area). In this way, the electronic processor utilizes the ML model 344 to detect whether a portion of a hand is present in the image data and then determines whether that detected hand is in the keep-out area.

As described above, a two-stage object detection model, such as an optical flow detection model, can be additionally or alternatively used to detect an unsafe operating condition of the powered saw. As a non-limiting example, the machine learning model can be used to perform hand detection at step 506 and an optical flow detection model can be additionally used to detect other motion between image frames of the image data received in step 502. For instance, the machine learning model can be used to generate detected hand data at step 506, which is then used to determine whether the user's hand intersects with a keep-out area, whereas the optical flow detection model can be used to generally detect fast moving objects within the image data. In this way, the optical flow model can be used to detect fast motion anywhere in the image frame, which can cover other unsafe operating conditions where injury may be likely to occur, such as the hand getting pulled into blade or otherwise toward the keep-out area, material and/or debris being forcefully ejected by the power saw, and/or environmental factors.

Thus, in some embodiments an optical flow model may be used to provide a secondary layer of detecting unsafe operating conditions, which can additionally be used to prevent injury to the user. Image data are input to the optical flow model to generate optical flow detection data as an output. The optical flow detection data may include an optical flow field, as described below, or additional data computed, derived, estimated, or otherwise generated from the optical flow field. As an example, additional data that can be generated from the optical flow field include images or parameters generated from the optical flow field, such as images indicating regions of motion, motion masks, images classifying different regions of motion based on displacement and/or velocity, bounding boxes containing regions of detected motion, and so on.

When an unsafe operating condition is identified, an unsafe operating condition output can be generated by the electronic processor 330, as indicated at step 510. The unsafe operating condition output may include a signal generated by the electronic processor 330 to direct the electronic controller 320 to control operation of one or more feedback devices 378, the motor 372 of the powered saw 300, or other such signals for controlling the electronic controller 320 to execute a safety action. As indicated above, in some instances the unsafe operating condition may be identified based on detecting whether a user's hand is moving into a keep-out area. Additionally or alternatively, the unsafe operating condition may be identified based on the output of an optical flow model indicating object motion within the image frame that could lead to potential user injury (e.g., unsafe motion towards the saw blade, unsafe motion of an object ejected from the power saw, unsafe environmental conditions).

Referring now to FIG. 7, a flowchart is illustrated as setting forth the steps of an example method for identifying whether a detected hand is present in a keep-out area of a powered saw.

The method includes receiving sensor data with the electronic processor 330, as indicated at step 702. In general, the sensor data include data acquired with one or more of the sensors 374. The sensor data may include inertial sensor data, such as accelerometer data, gyroscope data, magnetometer data, or the like. The sensor data may be received by the electronic processor 330 from the sensors 374. Additionally or alternatively, the sensor data may be received from the memory 340 by the electronic processor 330. Additionally or alternatively, receiving the sensor data may include acquiring such data with the sensors 374 and transferring or otherwise communicating the sensor data to the electronic controller 320.

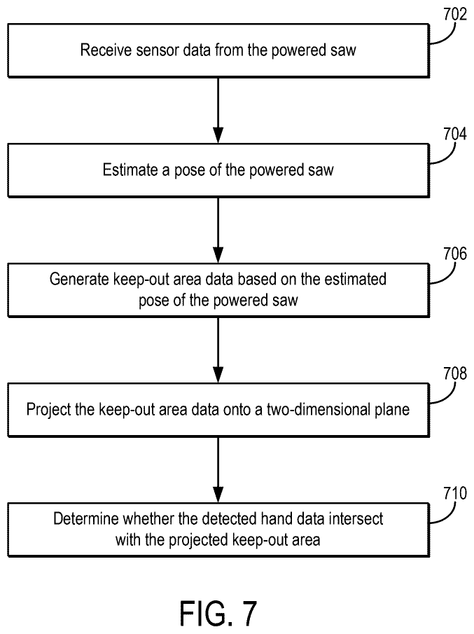

The sensor data are processed by the electronic processor 330 to estimate a pose of the powered saw, as indicated at step 704. The pose of the powered saw may include a position of the powered saw 300, an orientation of the powered saw 300, or both. For example, as illustrated in FIG. 8, the pose of the powered saw 300 may be estimated based on the sensor data and known saw geometry. In this way, the electronic controller 310 may receive an indication of the orientation of the saw blade of the powered saw 300 from the sensor data received by the sensors 374.

Using the estimated pose of the powered saw 300, the electronic processor 330 generates or otherwise determines keep-out area data that define one or more keep-out areas of the powered saw 300, as indicated at step 706. The keep-out area data may include one or more volumes defining one or more keep-out areas of the powered saw 300. For example, the keep-out area data may include a first volume defining a warning keep-out area and a second volume defining a danger keep-out area. As described above, in a non-limiting example, the warning keep-out area may include a volume that extends through a kerf plate of the powered saw 300 (e.g., as illustrated in the example of FIG. 1E). Similarly, in a non-limiting example, the danger keep-out area may include a volume that extends through the cutting plane of the saw blade of the powered saw 300 (e.g., as illustrated in the example of FIG. 1F). The keep-out area data may be adjusted by the user via one or more UI elements on the powered saw 300, as described above.

The electronic processor 330 then projects the keep-out areas in the keep-out area data onto a 2D plane (e.g., the 2D camera plane), as indicated at step 708. Projecting a keep-out area onto a 2D plane can include processing intrinsic and extrinsic parameters of the cameras 376. For instance, processing intrinsic parameters can include removing image distortions from the image data (e.g., when using a fish-eye lens, undistorting the image field-of-view onto a 2D plane) such that the detected hand data are mapped onto an undistorted camera plane. Processing extrinsic parameters can include using the estimated pose of the powered saw 300 to determine the position and orientation of the cameras 376 to facilitate projecting the volume associated with each keep-out area onto the undistorted 2D camera plane.

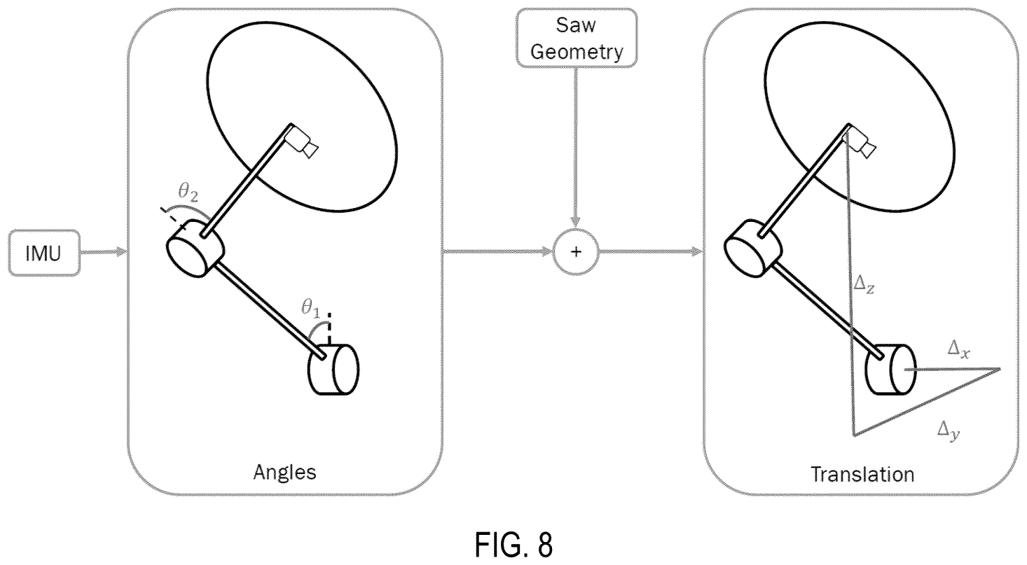

The electronic processor 330 then determines whether a detected hand in the detected hand data intersect with one or more of the projected keep-out areas, as indicated at step 710. When a detected hand object (e.g., a bounding box, a mask, etc.) in the detected hand data intersected with a projected keep-out area, the processor 330 determines that an unsafe operating condition exists and will generate the appropriate unsafe operating condition output for executing the associated safety action. For example, as illustrated in FIG. 9A, when a detected hand object 902 is identified as intersecting with a warning keep-out area 952, the electronic processor 330 can control the electronic controller 320 to execute safety actions associated with a warning condition (e.g., generating an appropriate auditory warning, visual warning, or both). On the other hand, as illustrated in FIG. 9B, when a detected hand object 902 is identified as intersecting with a danger keep-out area 954, the electronic processor 330 can control the electronic controller 320 to execute safety actions associated with a dangerous condition (e.g., stopping the saw blade in addition to generating an appropriate auditory warning, visual warning, or both).

Referring now to FIG. 10, a flowchart is illustrated as setting forth the steps of an example method for training a machine learning model for hand detection.

In general, the machine learning model can implement any number of different model architectures suitable for performing object detection. As a non-limiting example, the machine learning model may be an artificial neural network. The artificial neural network can be implemented as a convolutional neural network, a residual neural network, or the like.

The method includes accessing training data with a computer system, as indicated at step 1002. Accessing the training data may include retrieving such data from a memory or other suitable data storage device or medium. Alternatively, accessing the training data may include acquiring such data and transferring or otherwise communicating the data to the computer system. For example, the training data may include images captured using one or more cameras. As described above, in some examples the training data may include image data collected during operation of a powered saw 300.

In general, the training data can include images that each depict one or more hands. In some embodiments, the training data may include images that have been annotated or labeled (e.g., labeled as containing patterns, features, or characteristics indicative of one or more hands present in the images; and the like). As one example, the training data may include annotated images of hands scraped from videos, such as the 100 Days of Hands (100 DOH) dataset. Additionally or alternatively, the training data may include annotated images of first-person views of the hands of two people interacting, such as the EgoHands dataset. Additionally or alternatively, the training data may include annotated images of hands captured during operation of a powered saw in both safe and unsafe operating conditions. As described above, in some instances, the training data may include images captured during operation of the powered saw 300, which may be stored in the memory 340 for later use as training data.

The method can include assembling training data from image data using a computer system. This step may include assembling the image data into an appropriate data structure on which the machine learning model can be trained. Assembling the training data may include assembling image data, segmented image data, and other relevant data. For instance, assembling the training data may include generating labeled data and including the labeled data in the training data. Labeled data may include image data, segmented image data, or other relevant data that have been labeled as belonging to, or otherwise being associated with, one or more different classifications or categories. For instance, labeled data may include image data and/or segmented image data that have had one or more regions of the images labeled as containing or otherwise depicting a hand.

A machine learning model is then trained on the training data, as indicated at step 1004. In general, the machine learning model can be trained by optimizing model parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as detected hand data. The artificial neural network then compares the generated output with the actual output of the training example in order to evaluate the quality of the detected hand data. For instance, the detected hand data can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

As another example, the machine learning model may be a pretrained machine learning model, and training the pretrained machine learning model on the training data can include retraining, fine tuning, or otherwise updating the pretrained machine learning model using the training data. For instance, the machine learning model may be a pretrained neural network that is retrained to detect hands using transfer learning. In such instances, one or more of the final layers of the neural network can be removed and the neural network can be retrained on the training data. With this approach, a pretrained object detection model (e.g., a YOLO object detection model) can be specifically retrained to detect hands.

The trained machine learning model is then stored for later use, as indicated at step 1006. Storing the machine learning model may include storing model parameters (e.g., weights, biases, or both), which have been computed or otherwise estimated by training the machine learning model on the training data. When the machine learning model is a neural network, storing the trained machine learning model may also include storing the particular neural network architecture to be implemented. For instance, data pertaining to the layers in the neural network architecture (e.g., number of layers, type of layers, ordering of layers, connections between layers, hyperparameters for layers) may be stored.

As described above, the trained machine learning model may be stored on the memory 340 of the electronic controller 320 of the powered saw 300. For instance, the trained machine learning model may be stored as ML model 344 on the memory 340. The trained machine learning model may be communicated to the memory 340 via a wired or wireless connection. In some instances, the trained machine learning model may be stored on the memory 340 when the powered saw 300 is manufactured. In some other instances, the trained machine learning model may be communicated to the powered saw 300 at some point after the powered saw 300 has been manufactured. For example, the trained machine learning model may be communicated to the powered saw 300 as part of a firmware or other update to the powered saw 300. The ML model 344 may therefore be communicated (e.g., via wireless communication device 360, via a wired connection) to the electronic controller 320 and stored on the memory 340. Additionally or alternatively, an updated ML model 344 may be communicated (e.g., via wireless communication device 360, via a wired connection) to the electronic controller 320 and stored on the memory 340. The updated ML model 344 may include updated model parameters, an updated model architecture, or combinations thereof.

Referring now to FIG. 11, a flowchart is illustrated as setting forth the steps of an example method for identifying whether an unsafe operating condition of a powered saw exists based on processing image data using an optical flow detection model.

The method includes receiving image data with the electronic controller 320 (e.g., the electronic processor 330), as indicated at step 1102. In general, the image data received in step 1102 may be the same image data received by the electronic controller 320 in step 502 of the method illustrated in FIG. 502. Alternatively, the image data may include additional images or video captured by one or more cameras, which may include camera 376 or additional cameras in the work environment. The image data may therefore be received by the electronic processor 330 of the electronic controller 320 from the cameras 376, additional cameras in the work environment, or may additionally or alternatively be received from the memory 340 by the electronic processor 330. Additionally or alternatively, receiving the image data may include acquiring such data with the cameras 376 and transferring or otherwise communicating the image data to the electronic controller 320.

An optical flow detection model is then accessed with the electronic controller 320 (e.g., the electronic processor 330), as indicated at step 1104. As will be described, the optical flow detection model processes the image data to generate an optical flow field, from which motion of objects within the imaged field-of-view can be determined. The optical flow model may implement any number of suitable optical flow algorithms, processes, or methods. As a non-limiting example, the optical flow model may implement a Lucas-Kanade method, a Horn-Shunck method, or a Farnebäck method. In still other examples, the optical flow model may implement a dense optical flow method, a variational method, a sparse optical flow method, a pyramidal optical flow method, or the like. In some implementations, the optical flow detection model may be implemented by a machine learning model that is different from the machine learning model used for hand detection. For example, the optical flow detection model can include a machine learning model that implements an optical flow algorithm, such as a PWC-Net model, a FlowNet model, or the like. In use, a PWC-Net model receives consecutive image frames of the image data as an input and generates a corresponding optical flow field as an output.

The image data are then processed by the electronic processor 330 using the optical flow detection model to generate an optical flow field, as indicated at step 1106. In general, optical flow is the displacement of pixels between two consecutive image frames. For instance, optical flow can be measured as the apparent motion of an object between two consecutive frames caused by the movements of the object itself, other objects in the image frames, and/or the camera. An optical flow detection model is used to compute the optical flow field, which is a two-dimensional vector field where each vector is a motion vector showing the movement of points from the first frame to the second frame. These motion vectors provide information about the displacement and velocity for motion occurring in the images. Based on this optical flow field, objects that are moving between the image frames can be detected.

The electronic processor 330 then determines whether an unsafe operating condition is present based on the optical flow field, as indicated at step 1108. As a non-limiting example, detecting an unsafe operating condition based on the optical flow field can include processing the optical flow field with the electronic processor 330 to identify whether there is motion occurring between image frames of the image data that could result in an unsafe operating condition. For instance, the optical flow field can be processed by the electronic processor 330 to determine whether any motion vectors in the optical flow field indicate an object is moving towards one of the keep-out areas of the power saw. When the processor 330 determines that an unsafe operating condition exists it will generate the appropriate unsafe operating condition output for executing the associated safety action. For example, when the optical flow field indicates that an object is moving towards the warning keep-out area 952, the electronic processor 330 can control the electronic controller 320 to execute safety actions associated with a warning condition (e.g., generating an appropriate auditory warning, visual warning, or both). On the other hand, when the optical flow field indicates that an object is moving towards the danger keep-out area 954, the electronic processor 330 can control the electronic controller 320 to execute safety actions associated with a dangerous condition (e.g., stopping the saw blade in addition to generating an appropriate auditory warning, visual warning, or both). These actions may be performed additionally or alternatively to those performed based on the hand detection-based model implemented in the method of FIG. 7.

As another example, the optical flow field can be processed by the electronic processor 330 to determine whether any motion vectors in the optical flow field indicate an object is moving away from the power saw with a high velocity (e.g., when a piece of material is ejected from the power saw by a kickback event, or the like). In these instances, the motion vectors can be analyzed to determine if the displacement direction is towards an area likely to be occupied by a user (e.g., an area behind or otherwise in line with the saw blade of the power saw) and whether the velocity of the motion is above a safety threshold. If an object is moving towards a user at a low rate of speed, an unsafe operating condition may not be present, but if the object is moving at a higher rate of speed where an impact could cause injury to the user, then an unsafe operating condition may be present. The electronic processor 330 can then control the electronic controller 320 to execute safety actions associated with the unsafe operating condition (e.g., stopping the saw blade and/or generating an appropriate auditory warning, visual warning, or both).

In still other examples, the optical flow field can be processed by the electronic processor 330 to determine whether any motion vectors in the optical flow field indicate an object moving in the environment around the power saw that may indicate an unsafe operating condition. For instance, if the motion vectors in the optical flow field indicate significant motion around where the user can safely operate the power saw, then an unsafe operating condition can be detected. In this instance, the unsafe operating condition can indicate that the environment around the user may not allow for safe operation of the power saw. The electronic processor 330 can then control the electronic controller 320 to execute safety actions associated with the unsafe operating condition (e.g., stopping the saw blade and/or generating an appropriate auditory warning, visual warning, or both).

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

1. A powered saw comprising:
at least one camera;
an inertial measurement unit (IMU) sensor;
a saw blade;
a motor configured to drive the saw blade;
an electronic controller including an electronic processor and a memory, the electronic controller configured to:
receive an indication of an orientation of the saw blade from the IMU sensor;
determine a keep-out area based on the orientation of the saw blade, the keep-out area corresponding to the saw blade;
receive captured images from the at least one camera, the captured images including at least a portion of the keep-out area;
analyze, using a machine learning (ML) model, the captured images to determine whether a portion of a hand is present in the keep-out area; and
in response to detecting the portion of the hand in the keep-out area, execute a safety action.

2. The powered saw of claim 1, wherein the powered saw is a miter saw.

3. The powered saw of claim 1, wherein the powered saw is a table saw.

4. The powered saw of claim 1, wherein the safety action includes at least one selected from a group of: controlling a feedback light to generate a visual warning, controlling a feedback speaker to generate an audible warning, and controlling the motor to stop.

5. The powered saw of claim 1, wherein the keep-out area includes a warning zone and a danger zone, the danger zone being smaller than the warning zone.

6. The powered saw of claim 5, wherein the danger zone is at least partially contained within the warning zone.

7. The powered saw of claim 5,
wherein, in response to detecting the portion of the hand in the warning zone, the electronic controller is configured to generate a warning to execute a first safety action; and
wherein, in response to detecting the portion of the hand in the danger zone, the electronic controller is configured to execute a second safety action.

8. The powered saw of claim 7, wherein the first safety action comprises at least one of controlling a feedback light to generate a visual warning or controlling a feedback speaker to generate an audible warning.

9. The powered saw of claim 7, wherein the second safety action comprises controlling the motor to stop.

10. The powered saw of claim 9, wherein the second safety action further comprises at least one of controlling a feedback light to generate a visual warning or controlling a feedback speaker to generate an audible warning.

11. The powered saw of claim 1, wherein the at least one camera comprises two cameras.

12. The powered saw of claim 11, wherein the two cameras comprise a first camera arranged on one side of the saw blade and a second camera arranged on an opposite side of the saw blade.

13. The powered saw of claim 12, wherein the first camera and the second camera are arranged proximate the saw blade.

14. The powered saw of claim 1, wherein the electronic controller is further configured to:
generate optical flow field data by analyzing the captured images using an optical flow detection model;
determine a presence of an unsafe operating condition based on motion vectors contained in the optical flow field data; and
in response to detecting the presence of the unsafe operating condition, execute an additional safety action.

15. The powered saw of claim 14, wherein the additional safety action includes at least one of controlling a feedback light to generate a visual warning, controlling a feedback speaker to generate an audible warning, and controlling the motor to stop.

16. The powered saw of claim 14, wherein the presence of the unsafe operating condition is determined when at least one motion vector in the optical flow field data indicate motion of an object towards the keep-out area.

17. The powered saw of claim 14, wherein the presence of the unsafe operating condition is determined when at least one motion vector in the optical flow field data indicate motion of an object from the saw blade with a velocity above a safety threshold value.

18. The powered saw of claim 14, wherein the presence of the unsafe operating condition is determined when at least one motion vector in the optical flow field data indicate an unsafe environmental condition around the powered saw.

19. A method of operating a powered saw comprising:
receiving an indication of an orientation of a saw blade from a sensor of the powered saw;
determining a keep-out area based on the orientation of the saw blade, the keep-out area defining a volume relative to the saw blade;
receiving image data captured from a camera of the powered saw, the image data depicting at least a portion of the keep-out area;
analyzing, using a machine learning (ML) model, the image data to determine whether a portion of a hand is present in the keep-out area; and
executing a safety action in response to detecting the portion of the hand in the keep-out area.

20. The method of claim 19, wherein the orientation includes at least a bevel angle and a miter angle.

21. The method of claim 19, wherein the powered saw is a miter saw or a table saw.

22. The method of claim 19, wherein the safety action includes at least one selected from a group of: controlling a feedback light to generate a visual warning, controlling a feedback speaker to generate an audible warning, and controlling a motor of the powered saw to stop driving the saw blade.

23. The method of claim 19, wherein the keep-out area includes a warning zone and a danger zone, the danger zone being smaller than and within the warning zone.

24. The method of claim 23, further comprising:
in response to detecting the portion of the hand in the warning zone, executing the safety action by controlling a feedback device to generate a warning; and
in response to detecting the portion of the hand in the danger zone, controlling the motor to stop.

25. The method of claim 19, wherein analyzing the image data using the ML model comprises:
inputting the image data to the ML model using the electronic processor, generating detected hand data as an output, wherein the detected hand data indicate the portion of the hand detected in the image data;
generating a projected keep-out area by projecting the keep-out area onto a two-dimensional (2D) plane; and
determining whether the portion of the hand is present in the keep-out area by determining whether the detected hand data intersects with the projected keep-out area.

26. The method of claim 25, wherein the 2D plane is a 2D camera plane of the camera.

27. The method of claim 19, wherein the ML model comprises an object detection model.

28. The method of claim 27, wherein the object detection model comprises a one-stage object detection model.

29. The method of claim 28, wherein the one-stage object detection model is a You Only Look Once (YOLO) model.

30. The method of claim 27, wherein the object detection model comprises a two-stage object detection model.

31. The method of claim 30, wherein the two-stage object detection model is an optical flow detection model.
